(19) United States
(12) Patent Application Publication
(10) Pub. No.: US 2006/0173095 A1
(43) Pub. Date: Aug. 3, 2006

(54) Water-based ink for stencil printing and stencil printing method

(76) Inventors: Yoshifumi Watanabe, Ibaraki-ken (JP); Yoshihiro Hayashi, Ibaraki-ken (JP); Hiroshi Hayashi, Ibaraki-ken (JP)

Correspondence Address: NATH & ASSOCIATES, PLLC, 112 South West Street, Alexandria, VA, 22314, US

(21) Appl. No.: 11/337,512

(22) Filed: Jan. 24, 2006

(30) Foreign Application Priority Data
Feb. 1, 2005 (JP) P2005-025495

(51) Int. Cl. C09D 11/00

(52) U.S. Cl. 523/161

(57) ABSTRACT

There is disclosed a water-based ink for stencil printing that includes an associative thickener that is liquid at 20° C. By using this ink, the blurring of the printed image that occurs on recommencing printing after the printing machine has been sitting in an unused state can be eliminated quickly.

### CROSS REFERENCE TO RELATED APPLICATIONS

This Application is based upon and claims the benefit of priority from prior Japanese Application P2005-025495 filed on Feb. 1, 2005; the entire contents of which are incorporated by reference herein.

### BACKGROUND OF THE INVENTION

1. Field of the Invention

The present invention relates to a water-based ink for stencil printing, and more particularly to a water-based ink for stencil printing that is suitable for use in a rotary digital stencil printing machine, as well as a stencil printing method that uses such an ink.

2. Description of the Related Art

Compared with other printing methods such as offset printing, gravure printing, and letterpress printing, stencil printing offers significant advantages in terms of operability and convenience, including not requiring complex operations such as post-use cleaning operations, and not requiring a specialist operator. Since the introduction of thermal stencil making methods that use a thermal head as a perforation device, image processing within stencil printing methods has been able to be digitalized, enabling high quality printed products to be produced quickly and with comparative ease, and consequently the convenience of stencil printing continues to gain recognition, even as a method for information processing terminals.

Rotary stencil printing machines, in which the making, loading, and removal operations for the stencil master, as well as the ink supply operation and the printing operation are all controlled automatically, are widely used in offices and schools under names such as digital stencil duplicators.

Inks for stencil printing have conventionally been water-in-oil (W/O) emulsion inks. W/O emulsion inks have a function that inhibits variations in the ink composition or the ink properties when the printing machine is sitting unused, even if the ink inside the machine is in contact with the atmosphere. In other words, the water, which is the inner phase component of the emulsion ink, is covered with the outer phase oil component, meaning evaporation of the water is inhibited.

It is thought that the drying of printed material that has been printed using a W/O emulsion ink proceeds by a mechanism that relies on the penetration of the ink into the gaps between the fibers of the paper that functions as the print target (the print medium), and the gradual separation of the ink into an oil phase and a water phase as a result of contact with the paper fibers, thus enabling the water, which represents the major component of the ink, to contact the atmosphere and evaporate. However, the water within the ink transferred to the print medium is unable to undergo adequate contact with the atmosphere in the short period of time following printing, meaning the drying characteristics immediately following printing rely on drying by penetration. However, because the viscosity of a W/O emulsion ink is designed to be relatively high, the rate of penetration is not particularly fast, meaning the drying characteristics of the ink immediately following printing are not entirely satisfactory.

Due to their improved environmental friendliness and safety, water-based inks for stencil printing have also been developed, and a stencil printing method in which a base is applied to the printed surface immediately following printing, thereby improving the penetration of the water-based ink into the paper, is already known (see Japanese laid-Open Publication No. 2001-302955).

However, in water-based inks, a thickener is normally used to ensure a certain initial viscosity, but because the evaporation of the water that constitutes the ink is relatively fast on direct exposure to the atmosphere, if the ink is left exposed within an open system inside the printing machine, then evaporation of the water causes the viscosity of the ink to become overly high, which can cause considerable problems, including blurring (or incomplete ink coverage, or “faint and patchy” printing) of the printed image when printing is restarted after a lengthy period, and a requirement to clean the machine after printing. In order to overcome these problems, methods in which water evaporation prevention agents are added to the ink are also being tested, but further improvements are still required.

### SUMMARY OF THE INVENTION

The present invention relates to a water-based ink for stencil printing that comprises a non-ionic associative thickener that is liquid at 20° C.

Another aspect of the present invention relates to a stencil printing method that uses a water-based ink for stencil printing according to the above aspect of the present invention.

### DETAILED DESCRIPTION OF THE EMBODIMENTS

A water-based ink for stencil printing (hereafter, the term “water-based ink for stencil printing” is abbreviated as simply “ink”) according to the present invention comprises water, a colorant, and an associative thickener that is liquid at 20° C. In this description, the term “liquid at 20° C.” includes materials that exist as either viscous or non-viscous liquids at 20° C., although the viscosity of the liquid is preferably low.

Because an ink according to the present invention comprises an associative thickener that is liquid at 20° C., even if the water evaporates from the ink while sitting in an open system inside a printing machine, any changes in ink viscosity can be minimized. As a result, the blurring of the printed image that occurs on recommencing printing after the printing machine has been sitting in an unused state can be eliminated quickly.

In the description of the present invention, an associative thickener refers to a thickener which, in an aqueous medium, undergoes physical cross-linking as a result of molecules associating via hydrophobic interactions, causing the molecules to behave as if they were a single giant molecule, thereby thickening the system. Generally, these associative thickeners are (co)polymers comprising a hydrophilic region and a hydrophobic region, and the molecular weight is preferably at least 3,000 but no more than approximately 50,000. In addition, from the viewpoint of inhibiting separation of the ink components when the ink is left to sit in an open system, associative thickeners which are either water-soluble, or for which the hydrophilic-lipophilic balance (HLB) value is at least 10, are preferred.

The force known as hydrophobic interaction refers to the attractive force generated between two hydrophobic groups when those groups face one another in water, and the mechanism for the interaction is understood to represent an entropy effect. In other words, when a hydrophobic atom enters water, because the water molecules are unable to hydrogen bond with the hydrophobic atom solute, water molecules hydrogen bond together so as to enclose the solute, thereby stabilizing the enthalpy. However, this state has low entropy, with fewer structural degrees of freedom than a bulk state, meaning the overall solution has a high level of free energy, and is consequently unstable. As a result, the solute molecules aggregate together, causing a reduction in the number of water molecules bound within the hydration shells (through a reduction in the surface area of the hydrophobic molecules), thereby increasing the entropy and lowering the free energy within the system.

Examples of the chemical structures formed by associative thickeners include telechelic structures in which a hydrophobic group that is subject to hydrophobic interactions is bonded to a terminal of the principal chain of a hydrophilic polymer, and graft structures in which a hydrophobic group is copolymerized as a pendant group within a hydrophilic principal chain, and either of these structures is suitable.

In those cases where hydrophobic particles exist within the system, the associative thickener can also exhibit a thickening effect as a result of the hydrophobic groups adsorbing to the particle surfaces to form physical cross-linking structures.

In a stencil printing machine, because the ink used for printing is left sitting within an open system inside the stencil printing drum until it is required by the next printing operation, the overall volume of ink decreases as a result of water evaporation. With conventional inks that use water-soluble polymers as thickeners, as the concentration of the thickener increases with ongoing water evaporation, the polymer chains become more strongly intertwined, leading to a sudden increase in the viscosity of the ink.

In contrast, as described above, an associative thickener of the present invention thickens the system via an association mechanism based on hydrophobic interactions within the aqueous medium, and consequently, when the water within the ink disappears through evaporation, or when a proportion of water-soluble organic solvent added to the ink to maintain ink liquidity increases as the water evaporates, these hydrophobic interactions are lost, meaning the associative thickener ceases to function as a thickener. Accordingly, the ink viscosity is either reduced, or in those cases where a pigment is used as the colorant, the effects of any viscosity increase caused by an increase in the solid fraction concentration of the pigment are canceled out, enabling changes in the viscosity of the ink to be suppressed.

In addition, the use of an associative thickener which is itself liquid at 20° C. is a characteristic feature of the present invention. The inventors of the present invention have previously developed a water-based ink for stencil printing that comprises a non-ionic polymer containing hydrophobic groups at both terminals and a hydrophilic portion formed from a polyoxyalkylene chain within the molecular skeleton (see Japanese Unpublished Patent Application No. 2004-294155). In this prior application, the inventors investigated the blending of non-ionic polymers that were solid at room temperature, but as a result of further research, it became clear that by using a liquid associative thickener, the ink could be prevented from solidifying even after evaporation of the water, meaning increases in the ink viscosity could be suppressed, and favorable ink fluidity could be maintained. The suppression effect on viscosity increases provided by using a liquid associative thickener is markedly more powerful than simply increasing the quantity of water-soluble organic solvent within the ink. Accordingly, it is thought that by adopting the present invention, variations in ink viscosity and solidification of the ink can be prevented more effectively, even if the ink is left sitting in an open system inside the drum, and a favorable image can be reestablished more rapidly on recommencing printing after the printing machine has been sitting idle.

The hydrophobic groups of the associative thickener are preferably hydrocarbon groups such as alkyl groups, cycloalkyl groups, alkenyl groups, cycloalkenyl groups, aryl groups, alkyl-substituted aryl groups, or aryl-substituted alkyl groups. From the viewpoint of the resulting thickening action, the number of carbon atoms within these groups is preferably at least 6, and even more preferably 10 or greater (greater numbers of carbon atoms strengthen the hydrophobic interactions and the adsorption action). However, increasing the number of carbon atoms beyond a certain level produces no significant difference in the thickening effect, and so the number of carbon atoms is preferably no more than approximately 24, and considering the necessity to ensure that the thickener is liquid at room temperature, is preferably 18 or less.

Alkyl groups are particularly preferred as these hydrocarbon-based hydrophobic groups. These alkyl groups may include branched chains.

In terms of enhancing the thickening action, associative thickeners that contain a urethane group (a carbamate ester group) within the molecular skeleton are preferred. Urethane groups have a stronger molecular cohesive energy than other organic linkages, and are thought to strengthen the hydrophobic interactions between molecules.

There are no particular restrictions on the diisocyanate that constitutes the urethane group, and suitable examples include aliphatic diisocyanates such as tetramethylene diisocyanate and hexamethylene diisocyanate; aromatic diisocyanates such as p-phenylene diisocyanate, 2,4-tolylene diisocyanate (TDI), and xylylene diisocyanate; and alicyclic diisocyanates such as 1,4-cyclohexylene diisocyanate, 4,4′-dicylohexylmethane diisocyanate, and isophorone diisocyanate. Of these, hexamethylene diisocyanate, isophorone diisocyanate, and toluene diisocyanate (TDI) are preferred.

From the viewpoints of ensuring favorable stability of the thickener within water, and ensuring that the thickener remains liquid even if the water evaporates, enabling solidification of the ink to be prevented, the polymer that constitutes the hydrophilic region or hydrophilic principal chain of the associative thickener is preferably non-ionic, and liquid at room temperature.

Specifically, copolymers of ethylene oxide and an alkylene oxide of 3 to 4 carbon atoms are preferred, but the present invention is not restricted to such copolymers.

An example of an associative thickener containing such a urethane group is a structure represented by: alkyl group-alkylene oxide group (such as ethylene oxide-propylene oxide)-urethane group-alkylene oxide group (as above)-alkyl group.

The associative thickener described above can be used either alone, or in combinations of two or more different thickeners. The quantity of the thickener within the ink, or the combined quantity of the plurality of thickeners, is preferably within a range from 1 to 15% by weight, and even more preferably from 3 to 10% by weight. At quantities less than 1% by weight, a satisfactory thickening effect may not be obtainable, whereas increasing the quantity beyond 15% by weight may provide no additional benefits.

The associative thickener is preferably used in combination with a small quantity of an unsaturated carboxylic acid-based water-soluble polymer such as an acrylic acid-based water-soluble polymer.

Unsaturated carboxylic acid-based water-soluble polymers exhibit a powerful thickening effect, but if the quantity of such polymers is too large, then they can cause a dramatic increase in the viscosity of ink left sitting in an open system. In contrast, an associative thickener exhibits only a comparatively weak thickening action based on the hydrophobic interactions described above, but is able to suppress increases in ink viscosity when the ink is left sitting in an open system. Accordingly, by combining these two different thickeners, optimizing the quantity of ink transferred can be achieved with relative ease, while increases in the ink viscosity upon sitting in an open system can be suppressed.

The quantity of the unsaturated carboxylic acid-based water-soluble polymer varies depending on factors such as the type of polymer and the desired ink viscosity, but is typically within a range from 0.05 to 5.0% by weight, and even more preferably from 0.1 to 3.0% by weight, relative to the total weight of ink. At quantities less than 0.05% by weight, a satisfactory thickening effect may not be obtainable, whereas quantities exceeding 5.0% by weight may cause dramatic increases in the viscosity of ink left sitting in an open system.

An unsaturated carboxylic acid-based water-soluble polymer is preferably a water-soluble polymer comprising a repeating unit represented by a formula (1) shown below: 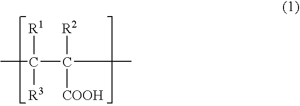
(wherein, R¹, R², and R³ each represent, independently, H, CH₃, or (CH₂)ₙCOOH (wherein, n is either 0 or 1)). In those cases where a polymer contains 2 or more carboxyl groups, these carboxyl groups may also form an acid anhydride group. In the case of a copolymer, a random, alternate, block, or graft copolymer may be used. Furthermore, the structure of the polymer chain may be either a straight chain or a cross-linked chain that includes cross-linking structures within the molecule.

Examples of this unsaturated carboxylic acid-based thickener include water-soluble polymers comprising, within the principal chain, one or more unsaturated carboxylic acids selected from the group consisting of acrylic acid and methacrylic acid (hereafter, these two are referred to jointly using the generic term (meth)acrylic acid), maleic anhydride, maleic acid, fumaric acid, crotonic acid, and itaconic acid, as well as the salts thereof. Specific examples include poly(meth)acrylic acid, acrylic acid-methacrylic acid copolymers, (meth)acrylic acid-maleic acid copolymers, (meth)acrylic acid-sulfonic acid-based monomer copolymers, (meth)acrylic acid-itaconic acid copolymers, (meth)acrylate ester-maleic acid copolymers, (meth)acrylic acid-(meth)acrylamide copolymers, (meth)acrylic acid-(meth)acrylate ester copolymers, (meth)acrylic acid-vinylpyrrolidone copolymers, polymaleic acid, polyfumaric acid, polycrotonic acid, polyitaconic acid, maleic anhydride-alkyl vinyl ether copolymers, as well as salts of these polymers.

The salts are preferably monovalent metal salts or amine salts, and specific examples of suitable salts, using polyacrylic acid as an example, include sodium polyacrylate, potassium polyacrylate, ammonium polyacrylate, and triethanolamine polyacrylate. Neutralized aqueous solutions prepared by mixing together, in water, a non-neutralized unsaturated carboxylic acid-based thickener and an alkaline neutralizing agent such as sodium hydroxide, potassium hydroxide, triethanolamine, or diisopropanolamine can also be used.

The ink may also comprise one or more other water-soluble polymer-based thickeners or clay mineral-based thickeners, besides the aforementioned unsaturated carboxylic acid-based thickener.

Examples of these other water-soluble polymer-based thickeners include plant-based natural polymers such as gum arabic, carageenan, guar gum, locust bean gum, pectin, tragacanth gum, corn starch, konjac mannan, and agar; microbial natural polymers such as pullulan, xanthan gum, and dextrin; animal-based natural polymers such as gelatin, casein, and animal glue; cellulose-based semisynthetic polymers such as ethylcellulose, carboxymethylcellulose, hydroxyethylcellulose, hydroxypropylcellulose, methylcellulose, and hydroxypropylmethylcellulose; starch-based semisynthetic polymers such as hydroxyethyl starch, sodium carboxymethyl starch, and cyclodextrin; alginate-based semisynthetic polymers such as sodium alginate and propylene glycol alginate; sodium hyaluronate; and synthetic polymers such as polyvinylpyrrolidone, polyvinyl alcohol, polyvinyl methyl ether, poly-N-vinylacetamide, polyacrylamide, polyethylene oxide, polyethyleneimine, and polyurethane.

Examples of clay mineral-based thickeners include smectite-based clay minerals such as montmorillonite, hectorite, and saponite.

Depending on the nature of the compound and the quantity added, the water-soluble polymers listed above as possible thickeners may also be used for purposes other than thickening the ink, including as fixing agents for fixing colorants to the printing paper. Furthermore, in those cases where pigments are used as colorants, the water-soluble polymers may also be used as pigment dispersing agents.

From the viewpoint of improving the drying characteristics of the printed material, water preferably accounts for at least 50% by weight, and even more preferably 65% by weight or more, of the ink. The water contained within the ink can evaporate into the atmosphere immediately following printing. In addition, it is thought that by forcing the ink to penetrate into the gaps between the fibers of the printing paper during printing, the contact surface area between the ink and the air expands rapidly within the interior of the printing paper, further improving the evaporation rate of the water, and as a result, increasing the quantity of water further improves the drying characteristics of the printed material. Although there are no particular restrictions on the upper limit for the blend quantity of the water, the quantity is preferably set to ensure a favorable balance with the other components of the ink.

In order to preventing drying of the ink within the perforated portions of the stencil master during printing, a water-soluble organic solvent is preferably also added to the ink.

This water-soluble organic solvent is a liquid at room temperature, and is soluble in water. Suitable examples include lower alcohols such as methanol, ethanol, 1-propanol, isopropanol, 1-butanol, 2-butanol, isobutanol, and 2-methyl-2-propanol; glycols such as ethylene glycol, diethylene glycol, triethylene glycol, tetraethylene glycol, pentaethylene glycol, propylene glycol, dipropylene glycol, and tripropylene glycol; glycerol; acetins (monoacetin, diacetin, and triacetin); glycol derivatives such as triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; as well as triethanolamine, β-thiodiglycol, and sulfolane. Low molecular weight polyalkylene glycols, including polyethylene glycol with an average molecular weight within a range from 190 to 630, such as an average molecular weight of 200, 300, 400, or 600, polypropylene glycol diol with an average molecular weight within a range from 200 to 600, such as an average molecular weight of 400, and polypropylene glycol triol with an average molecular weight within a range from 250 to 800, such as an average molecular weight of 300 or 700, can also be used. These water-soluble organic solvents can be used either alone, or in combinations of two or more different solvents.

The quantity of the water-soluble organic solvent within the ink is preferably at least 5% by weight, and even more preferably 10% by weight or greater. Although there are no particular restrictions on the upper limit for this quantity, in order to avoid image show through, the quantity is preferably no more than approximately 45% by weight, and even more preferably no more than approximately 35% by weight. By incorporating at least 5% by weight of a water-soluble organic solvent with a higher boiling point than water, and preferably a boiling point of at least 150° C., drying of the perforated portions of the stencil master during printing can be effectively prevented.

The colorant can use either pigments or dyes, or a combination of two or more such colorants. Suitable pigments include organic pigments such as azo-based pigments, phthalocyanine-based pigments, dye-based pigments, condensed polycyclic pigments, nitro-based pigments, and nitroso-based pigments (such as brilliant carmine 6B, lake red C, Watchung red, disazo yellow, Hansa yellow, phthalocyanine blue, phthalocyanine green, alkali blue, and aniline black); inorganic pigments, including metals such as cobalt, iron, chrome, copper, zinc, lead, titanium, vanadium, manganese, and nickel, as well as metal oxides, metal sulfides, yellow ocher, ultramarine, and iron blue pigments; and carbon blacks such as furnace carbon black, lamp black, acetylene black, and channel black. Suitable dyes include those basic dyes, acid dyes, direct dyes, soluble vat dyes, acid mordant dyes, mordant dyes, reactive dyes, vat dyes, and sulfide dyes that are water soluble, as well as those dyes that have been converted to a water-soluble form through reduction or the like. Either pigments and/or dyes can be used as the colorant, but the use of pigments is preferred, as they enable production of an ink that exhibits minimal bleeding or image show through, and excellent weather resistance.

The quantity of colorant within the ink is preferably within a range from 1 to 20% by weight, and even more preferably from 3 to 10% by weight. In order to maximize the print density of the printed material, the colorant quantity is preferably at least 5% by weight.

The ink may also include suitable quantities of pigment dispersing agents, fixing agents, antifoaming agents, surface tension reduction agents, pH regulators, antioxidants, and preservatives, in addition to the components described above.

An alkali-soluble resin may also be added to the ink as a fixing agent for improving the fixation of the colorant to the print target such as the printing paper. In those cases where a pigment is used as the colorant, an alkali-soluble resin can also be used as a pigment dispersing agent.

Examples of suitable alkali-soluble resins include styrene-acrylic acid copolymers, styrene-a-methylstyrene-acrylic acid copolymers, styrene-methacrylic acid copolymers, styrene-acrylate ester-acrylic acid copolymers, styrene-maleic anhydride copolymers, vinylnaphthalene-acrylic acid copolymers, vinylnaphthalene-maleic acid copolymers, isobutylene-maleic anhydride copolymers, acrylate ester-acrylic acid copolymers, methacrylate ester-acrylic acid copolymers, acrylate ester-methacrylic acid copolymers, methacrylate ester-methacrylic acid copolymers, and acrylate ester-methacrylate ester-acrylic acid copolymers, and a combination of two or more of these resins may also be used. These alkali-soluble resins can be neutralized and converted to a water-soluble form using a suitable alkali, including an alkali metal hydroxide such as sodium hydroxide or potassium hydroxide, ammonia water, or an alkanolamine such as triethanolamine.

If a large quantity of alkali-soluble resin is added, then there is a danger of interfering with the printing performance of the printing machine following a period of non-use, and consequently the quantity of alkali-soluble resin within the ink, calculated as a solid fraction percentage, is preferably no more than 5% by weight, and even more preferably 3% by weight or less.

An oil-in-water (O/W) resin emulsion can also be incorporated within the ink, and used as a fixing agent for fixing the colorant to the printing paper or the like that functions as the print target (the print medium). In those cases where a pigment is used as the colorant, this resin emulsion can also be used as a pigment dispersing agent.

Examples of suitable oil-in-water (O/W) resin emulsions include emulsions of polyvinyl acetate, ethylene-vinyl acetate copolymers, vinyl acetate-acrylate ester copolymers, polyacrylate ester, polymethacrylate ester, polystyrene, styrene-acrylate ester copolymers, styrene-butadiene copolymers, vinylidene chloride-acrylate ester copolymers, polyvinyl chloride, vinyl chloride-vinyl acetate copolymers, and polyurethane and the like. Combinations of two or more of these emulsions may also be used.

If a large quantity of resin emulsion is added, then there is a danger of interfering with the printing performance of the printing machine following a period of non-use, and consequently the quantity of resin emulsion within the ink, calculated as a solid fraction percentage, is preferably no more than 5% by weight, and even more preferably 2% by weight or less.

Extender pigments may also be added to the ink to improve the image quality of the printed material.

Examples of suitable extender pigments include white clay, talc, clay, diatomaceous earth, calcium carbonate, barium carbonate, barium sulfate, alumina white, silica, kaolin, mica, and aluminum hydroxide, and combinations of two or more of these extender pigments may also be used.

If a large quantity of extender pigment is added, then there is a danger of inhibiting the fixation of the colorant to the print target, and interfering with the printing performance of the printing machine following a period of non-use, and consequently the quantity of extender pigment is preferably no more than 5% by weight, and even more preferably 2% by weight or less.

In addition, anionic surfactants, cationic surfactants, amphoteric surfactants, nonionic surfactants, or polymer-based, silicone-based or fluorine-based surfactants may also be added to the ink as pigment dispersing agents, antifoaming agents, or surface tension reduction agents or the like.

An electrolyte may also be added to the ink to allow regulation of the ink viscosity or pH. Examples of suitable electrolytes include sodium sulfate, potassium hydrogenphosphate, sodium citrate, potassium tartrate, and sodium borate, and combinations of two or more of these electrolytes may also be used. Other materials such as sulfuric acid, nitric acid, acetic acid, sodium hydroxide, potassium hydroxide, ammonium hydroxide, and triethanolamine and the like may also be used in the ink as thickening assistants or pH regulators.

By adding an antioxidant, oxidation of the ink components can be prevented, and the storage stability of the ink can be improved. Examples of suitable antioxidants include L-ascorbic acid, sodium Iascorbate, sodium isoascorbate, potassium sulfite, sodium sulfite, sodium thiosulfate, sodium dithionite, and sodium pyrosulfite.

By adding a preservative, degradation of the ink can be prevented, enabling the storage stability to be improved. Examples of suitable preservatives include isothiazolone-based preservatives such as 5-chloro-2-methyl-4-isothiazolin-3-one, 2-methyl-4-isothiazolin-3-one, 2-n-octyl-4-isothiazolin-3-one, and 1,2-benzoisothiazolin-3-one; triazine-based preservatives such as hexahydro-1,3,5-tris(2-hydroxyethyl)-s-triazine; pyridine or quinoline-based preservatives such as sodium 2-pyridinethiol-1-oxide and 8-oxyquinoline; dithiocarbamate-based preservatives such as sodium dimethyldithiocarbamate; organobromine-based preservatives such as 2,2-dibromo-3-nitrilopropionamide, 2-bromo-2-nitro-1,3-propanediol, 2,2-dibromo-2-nitroethanol, and 1,2-dibromo-2,4-dicyanobutane; as well as methyl p-hydroxybenzoate, ethyl p-hydroxybenzoate, potassium sorbate, sodium dehydroacetate, and salicylic acid.

The ink can be produced by mixing the water, the colorant, and the aforementioned associative thickener, together with any of the other optional components described above as desired. For example, a portion of the water, the pigment, and the pigment dispersing agent can be mixed together, and a dispersion device such as a ball mill or beads mill then used to disperse the pigment, while the remainder of the water, the thickener, and the water-soluble organic solvent are also mixed together, before the two separate mixtures are then combined and mixed.

The most appropriate range for the ink viscosity varies depending on factors such as the printing pressure of the printing apparatus, but is typically within a range from approximately 0.5 to approximately 20 Pa·s (the viscosity is measured at 20° C., using a shear rate of 100/s), and (pseudo) plastic flow characteristics are ideal for stencil printing.

A stencil printing method according to the present invention is conducted using the ink according to the present invention described above. Specifically, the method comprises: preparing a stencil master; and pressing the produced stencil master and a print target together, thereby causing the ink of the present invention to pass through the perforated portions of the stencil master and onto the print target.

There are no particular restrictions on the printing machine used, although because of their superior operability, digital stencil printing machines are preferred.

### EXAMPLES

As follows is a more detailed description of the present invention using a series of examples, although the present invention is in no way limited by these examples. In the following description, the units “% by weight” are abbreviated simply as “%”.

### Example 1

As shown in Table 1, (1) 5.0% of carbon black (CF9, manufactured by Mitsubishi Chemical Corporation) as a colorant, (2) 3.3% (the value in the table refers to the equivalent solid fraction value) of an ammonium acrylate-acrylate ester copolymer (Jurymer AT210, a polyacrylate copolymer manufactured by Nihon Junyaku Co., Ltd., solid fraction: 30%) as a pigment dispersing agent, and 16.7% of ion exchange water were mixed together, and were then dispersed thoroughly using a beads mill, thus yielding a pigment dispersion. Meanwhile, (3) 0.5% of a carboxyvinyl polymer (Carbopol 940, manufactured by BF Goodrich Company) as a thickener was dissolved in 14.0% of ion exchange water, and following neutralization of the resulting solution by addition of (8) 0.5% of triethanolamine, the neutralized solution was combined with the previously prepared pigment dispersion, (7) 22.0% of diethylene glycol, the remaining quantity of ion exchange water (35.0%), and (4) 3.0% of a urethane-modified polyoxyalkylene (ethylene oxide and propylene oxide) dialkyl ether (Bermodol PUR 2110, manufactured by Akzo Nobel N.V.), and the resulting combination was then mixed thoroughly, yielding an ink of the example 1.

### Examples 2 to 4, Comparative Examples 1 and 2

With the exception of using the compositions shown in Table 1, inks for each of the examples and comparative examples were prepared in the same manner as the example 1. In the Table 1, the urethane-modified polyoxyalkylene (ethylene oxide and propylene oxide) dialkyl ether labeled (5) refers to Elfacos T212, manufactured by Akzo Nobel N.V., and the urethane-modified polyoxyalkylene dialkyl ether labeled (6) refers to Adekanol UH420 manufactured by Asahi Denka Co., Ltd. (solid fraction: 30%, the value in the table refers to the equivalent solid fraction value).

When ascertaining the properties of the associative thickeners (4) to (6) (such as whether they are solid or liquid), the water was evaporated from the product (6) to enable evaluations to be conducted on the neat active ingredient.

Using each of the inks (the water-based inks for stencil printing) prepared in the examples 1 to 4 and the comparative examples 1 and 2, printing was conducted onto printing paper (Riso lightweight paper, manufactured by Riso Kagaku Corporation) using a stencil printing machine (Risograph RP370, manufactured by Riso Kagaku Corporation), and following printing, the machine was left to stand for 15 hours in an environment at 23° C. and 50% RH. Subsequently, a newly prepared stencil was wound onto the printing drum of the printing machine, printing was recommenced, and the quality of the thus produced print image was inspected.

The quality of the image at printing startup following the recommencement of printing (the image reestablishment following a period of non-use) was evaluated using the following criteria. A: a non-blurred image was obtained within 10 copies, C: even after printing 50 copies, the image remained blurred.

The results are shown in Table 1.

TABLE 1

| | | | | | | | Comparative | |
|---|---|---|---|---|---|---|---|---|
| | | | Example | | | | example | |
| Blend ratio/% by weight | | | 1 | 2 | 3 | 4 | 1 | 2 |
| Colorant | Carbon black | (1) | 5.0 | 5.0 | 5.0 | 5.0 | 5.0 | 5.0 |
| Pigment | Polyacrylate | (2) | 1.0 | 1.0 | 1.0 | 1.0 | 1.0 | 1.0 |
| dispersing agent | copolymer | | | | | | | |
| Thickener | Carboxyvinyl polymer | (3) | 0.5 | 0.3 | 0.2 | — | 0.5 | 0.5 |
| Liquid non-ionic | Urethane-modified | (4) | 3.0 | 7.0 | — | 15.0 | — | — |
| associative thickener | polyoxyalkylene | | | | | | | |
| (telechelic) | dialkyl ether | | | | | | | |
| | Urethane-modified | (5) | — | — | 5.0 | — | — | — |
| | polyoxyalkylene | | | | | | | |
| | dialkyl ether | | | | | | | |
| Solid non-ionic | Urethane-modified | (6) | — | — | — | — | — | 3.0 |
| associative thickener | polyoxyalkylene | | | | | | | |
| (telechelic) | dialkyl ether | | | | | | | |
| Water-soluble organic | Diethylene glycol | (7) | 22.0 | 18.0 | 20.0 | 10.0 | 25.0 | 22.0 |
| solvent | | | | | | | | |
| Neutralizing agent | Triethanolamine | (8) | 0.5 | 0.3 | 0.2 | — | 0.5 | 0.5 |

| | | | | | | |
|---|---|---|---|---|---|---|
| Ion exchange water | 68.0 | 68.4 | 68.6 | 69.0 | 68.0 | 68.0 |

| Total | | 100.0 | 100.0 | 100.0 | 100.0 | 100.0 | 100.0 |
|---|---|---|---|---|---|---|---|
| Evaluation | Image | A | A | A | A | C | C |
| | reestablishment | | | | | | |
| | following period | | | | | | |
| | of non-use | | | | | | |

All of the inks of the examples enabled a non-blurred image to be obtained within 10 copies of recommencing printing. In contrast, the inks of the comparative examples yielded blurred images even after printing 50 copies.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A water-based ink for stencil printing, comprising a non-ionic associative thickener that is liquid at 20° C.

2. The water-based ink for stencil printing according to claim 1, wherein the non-ionic associative thickener comprises a urethane group within a molecular skeleton.

3. The water-based ink for stencil printing according to claim 1, wherein a quantity of the non-ionic associative thickener is within a range from 1 to 15% by weight.

4. The water-based ink for stencil printing according to claim 1, further comprising an unsaturated carboxylic acid-based water-soluble polymer.

5. A stencil printing method that uses the water-based ink for stencil printing according to claim 1.
